(19) United States
(12) Patent Application Publication
(10) Pub. No.: US 2009/0025231 A1
(43) Pub. Date: Jan. 29, 2009

(54) Container Scoop With Arcuate Bottom Edge

(76) Inventor: Larry Salvino, Wauconda, IL (US)

Correspondence Address: VEDDER PRICE P.C., 222 N. LASALLE STREET, CHICAGO, IL, 60601, US

(21) Appl. No.: 11/829,713

(22) Filed: Jul. 27, 2007

(51) Int. Cl. B26B 27/00; A47J 43/28; A47L 17/06

(52) U.S. Cl. 30/169; 15/236.01

(57) ABSTRACT

A handheld tool for removing materials from a cylindrical container including a handle, first and second sidewalls and a flat bottom with an outside arcuate edge. The tool can also be used for scraping, scooping and/or clearing contents off the sidewalls and bottom of a cylindrical container.

### BACKGROUND OF THE INVENTION

1. Field of the Invention

This disclosure relates to a handheld tool for removing the contents of and scraping clean a container of solids, solid particles, semi-solid materials, and semi-liquid materials, and more specifically, a handheld tool designed for removing, scraping, scooping, and/or clearing the contents of a cylindrical container.

2. Prior Art

Removing residual material from a cylindrical container has always proven to be difficult. For example, when one wishes to remove a semi-liquid or semi-solid material from a container, oftentimes the container must be tilted to one side and the user must employ both hands in holding the container and the device for removing the material. This frequently results in the spillage of and contact with the material by the user. A further example is joint compound, which is sold in cylindrical containers. Joint compound is used to cover tape that seals the joints of sheets of drywall for construction of interior walls of buildings. The joint compound is typically scooped out of the container and applied to the drywall. The scooping operation may comprise the use of tools, cups, trowels, etc., all of which easily result in the spillage and waste of the joint compound. It is desired to have a specialized tool for scooping and scraping joint compound from a cylindrical container, as well as other semi-liquid, semi-solid, and solid materials.

### SUMMARY OF THE INVENTION

The present invention is an improved hand tool that can be used in a variety of applications for removing, scraping, scooping, and/or cleaning product from a cylindrical container. The tool includes a handle, first and second sidewalls connected to the handle, and a flat bottom with an arcuate edge attached to the sidewalls. The tool is adapted to be handheld and includes a generally longitudinally extending handle. The sidewalls are cooperating elements with the handle and the flat bottom which has a generally arcuate edge. The cooperating elements form a device for lifting material from a container. The edges of the sidewalls and arcuate edge of the flat bottom function to scrape residual material from the sidewalls and bottom of a cylindrical container for removal.

### BRIEF DESCRIPTION OF THE DRAWINGS

Throughout the following description and in the drawings, identical reference numbers are used to refer to the same component shown in multiple figures of the drawings, in which:

FIG. 1 is a perspective view of an embodiment of the present invention;

FIG. 2 is a side view showing an embodiment of the present invention of a front surface of one sidewall;

FIG. 3 is a side view showing an embodiment of the present invention conforming to the back side of one wall of the present invention;

FIG. 4 is a bottom view of the flat bottom of the present invention; and

FIG. 5 is an alternate embodiment of the present invention.

### DETAILED DESCRIPTION OF THE INVENTION

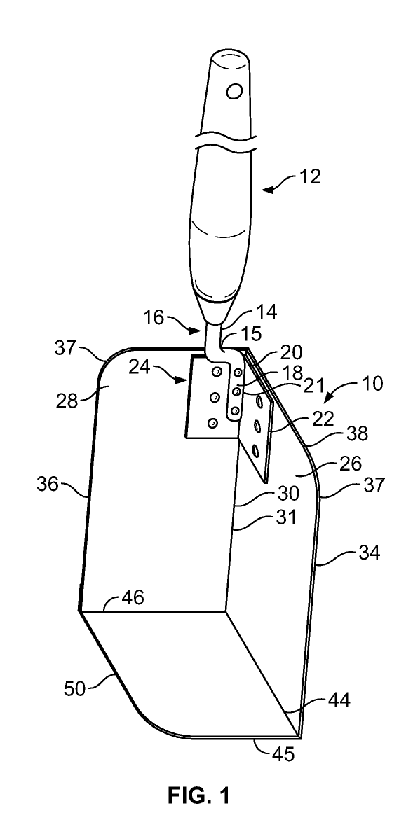

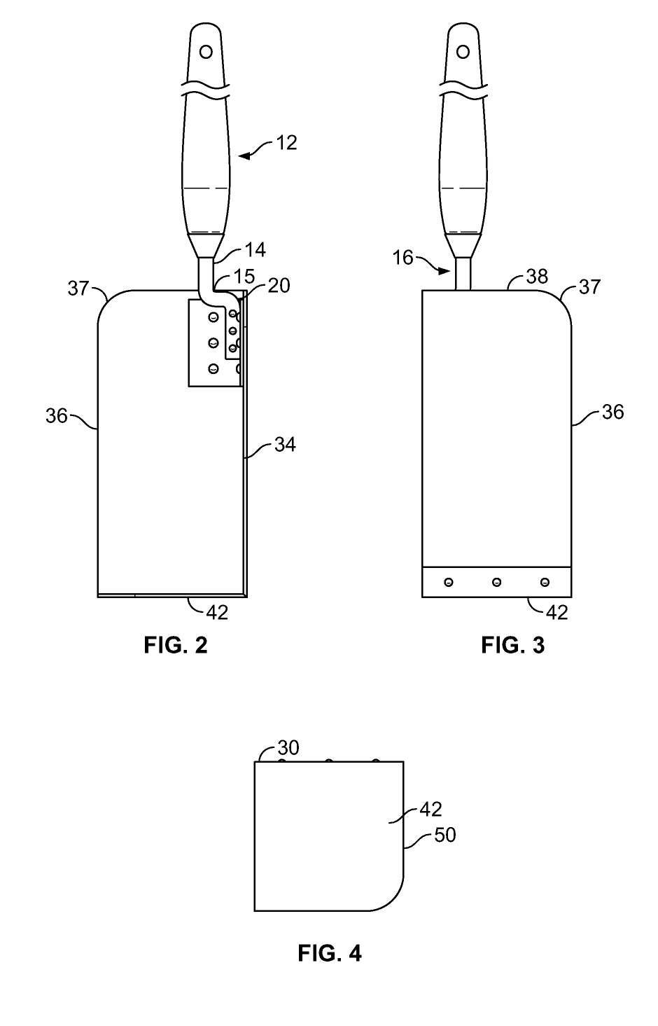

FIGS. 1-4 illustrate an embodiment of the present invention, which is an improved hand tool for scooping and removing semi-solid, solid, and semi-liquid products from a cylindrical container in an efficient manner. The tool is designed to fit or meet the inside radial contour of a container to facilitate removal of the products from the container without spillage and without product residue remaining in the container.

The handheld scoop and scraper tool 10 may be used to efficiently scoop materials, such as solids, semi-solids, semi-liquids, and joint compound from the cylindrical container. The tool 10 allows a worker to efficiently remove all of the materials from the cylindrical container in an efficient, clean manner. The tool 10 includes handle 12, which may be made from wood, plastic, metal, or the like, attached to connector 14. In the embodiment shown in FIG. 1, connector 14 has a 90° elbow 15 with an upper section 16 connecting to the handle, and a lower section 18 below the elbow, which is attached to connecting plate 20 with first and second sides 22, 24, respectively. The plates are attached to first sidewall 26 and second sidewall 28, respectively. The inside edges 30 of the sidewalls meet to form joint 31 so that the angle of the joint is the same as the angle of the connector joint 21 of the first side connector plate 22 and second side connector plate 24. Lower section 18 is attached to the connector plate 20 by rivets, bolts, soldering, or other suitable means. First side 22 and second side 24 connector plates are attached to the first and second sidewalls, respectively, by suitable, conventional means, for example, riveting or soldering.

First and second sidewalls 26, 28 have outside edges 34, 36, respectively. Outside edges 34, 36 of side sidewall 26 and second sidewall 28 have rounded edge 37 at the top 38 and the respective outside edge slopes downwardly. Flat bottom 42 has a first inside edge 44 for meeting first sidewall 26 and second inside wall 46 for meeting second sidewall 28. Outside edge 50 of the flat bottom plate is arcuate and contoured to fit the bottom of a cylindrical container in that it is approximately equal to the radius of the cylindrical container (not shown). Outside edge 50 may be constructed in different sizes to fit different sized cylindrical containers. The meeting of the sidewalls together and the meeting of the sidewalls with the flat bottom cooperatively form a device for scooping and retaining solids, semi-solids, and semi-liquid materials for removal from the cylindrical container. The tool may also facilitate removal of bulk items, grain particles, and manufactured articles, etc. The tool can also be used in other containers, including, for example, flexible paper bags and the like, where the outer edge 50 of the flat bottom plate can be easily manipulated.

The tool can be manufactured from steel, aluminum, or rigid plastic, such as polypropylene or other suitable material.

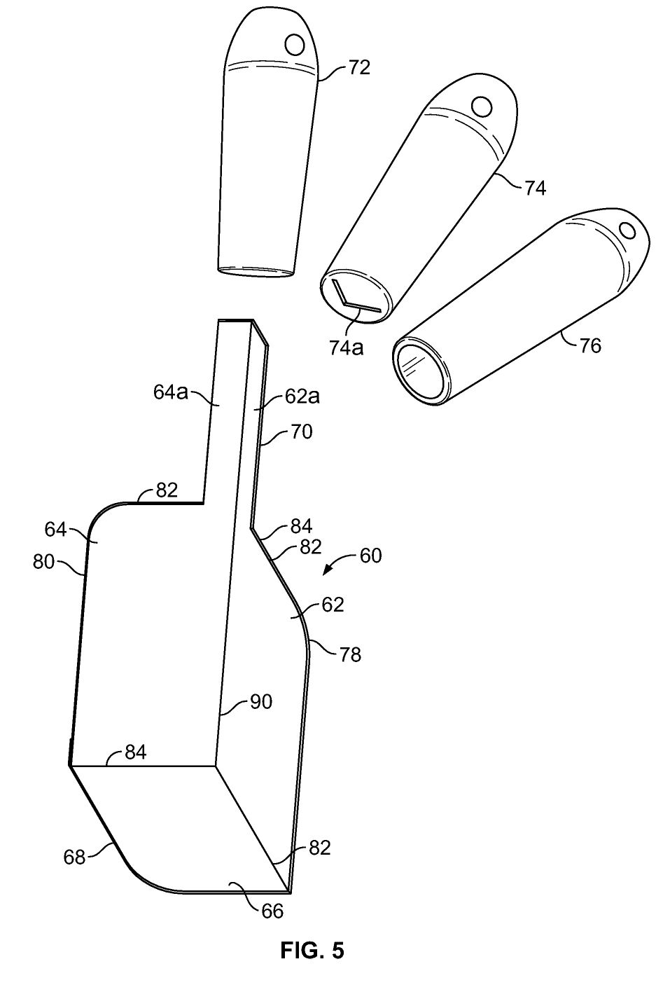

In an alternate embodiment shown in FIG. 5, a one-piece tool 60 is presented. One-piece tool 60 has an integrated construction or assembly with sidewalls 62, 64 and bottom 66 with arcuate edge 68 extending downwardly from neck 70. Neck 70 is preferably connected to a handle selected from handles 72, 74, or 76. Neck 70 may also be shaped into a suitable, comfortable handle. Handle 74 has slot 74a for elongated receiving neck 70 having two sidewall extensions 62a, 64a. The sidewall extensions are sealed in handle 74 and slot 74a by adhesive or other suitable means. Handles 72 and 76 respectively, receive neck 70 and are packed with suitable filling materials not shown. Tool 60 otherwise has a structure similar to tool 10 and includes sidewalls 62, 64 outside edges 78, 80, rounded edge 82 at top 84, and inside edge 90 for meeting sidewalls 62, 64. Sidewalls 62, 64 have lower edges 82 and 84 respectively which meet flat bottom, 66. Flat bottom 66 utilizes arcuate edge 68 for the same functions as previously described.

In operation, tool 10 is grasped at the handle 12 by the worker. It is inserted into the container in a downward motion to lower it into the container. The tool is filled with the product, for example, joint compound. The worker then pulls the tool 10 upwardly and removes product from the container. Edge 50 of the tool may follow the contoured inside wall of the container. It may also be inserted at an angle in order to readily fill the scoop. Edge 50 also follows the contour of the wall as it joins the bottom of the container. The arcuate edge will receive materials from any general movement of the user's wrist and hand, that is, by rotation or upward and downward movement. The sidewalls and arcuate bottom edge are an improvement over hard, conventional open scoops and shovels typically used to remove materials from containers.

Upon emptying the container, the worker can intermittently use the tool to wipe or scrape the inside of the container clean by allowing edge 50 to follow the inside wall of the container in a downward motion while moving it around the perimeter of the container. This movement clears the inside wall of the container. The bottom of the container may also be cleaned of remaining product. The tool can be placed on the bottom of the container so that flat bottom 42 is adjacent thereto. The tool is rotated so that edge 50 engages the bottom and inside wall of the container to efficiently remove product from the bottom of the container.

The sidewalls or inside edge of a container can be cleaned by contacting the tool 10 with the inside edge or sidewall of a container and moving it around the wall. Outside edges 34, 36 may scrape the wall along with flat bottom 42 and outside edge 50.

It will be clear that tool 10 is capable of many applications and uses to one skilled in the art. The tool can be used with assorted products, such as joint compounds, adhesives and food products.

The invention has been described in its presently contemplated best mode. Various modifications and embodiments, all within the ability of those skilled in the art can be made without further inventive activity. Accordingly, what is intended to be protected is set forth in the appended claims.

What is claimed is:

1. A tool for removing materials from a cylindrical container by scooping and scraping, comprising:
a handle;
first and second side walls connected to the handle extending longitudinally and from the handle; and
a flat bottom having an arcuate edge attached to the side walls.

2. The tool of claim 1, wherein said handle is attached to a upper section of a connector with an upper section and a lower section, said upper section connected to the handle.

3. The tool of claim 2, wherein the second end of said connecting rod is attached to a connecting plate having first and second sides.

4. The tool of claim 3, wherein the first and second sides of the connecting plate are attached to the first and second sidewalls.

5. The tool of claim 4, wherein the first and second side walls include outside, inside, top, and bottom edges.

6. The tool of claim 5, wherein the inside edges of the sidewalls meet at a 90° angle.

7. The tool of claim 4, wherein the top edges of the side walls include an outside corner opposite the inside edge that is rounded.

8. The tool of claim 5, wherein the flat bottom has first, second, third, and fourth edges and wherein the first and second edges are attached to the first and second sidewalls.

9. The tool of claim 8, wherein the third and fourth edges meet at a rounded corner.

10. The tool of claim 1 wherein the first and second side walls and bottom are a one-piece assembly.

11. The tool of claim 10 wherein the one-piece assembly has an elongated neck.

12. The tool of claim 11 wherein the one-piece assembly has a handle attached to the elongated neck.
